(19) United States
(12) Patent Application Publication
(10) Pub. No.: US 2018/0222663 A1
(43) Pub. Date: Aug. 9, 2018

(54) Chemiluminescent Aerosol Sprayer

(71) Applicants: Michael Scott Fishman, Parkland, FL (US); Neal Markus, Hollywood, FL (US)

(72) Inventors: Michael Scott Fishman, Parkland, FL (US); Neal Markus, Hollywood, FL (US)

(21) Appl. No.: 15/424,068

(22) Filed: Feb. 3, 2017

(51) Int. Cl. B65D 83/68; B65D 83/20; B65D 83/32; B65D 83/48; B65D 83/62; B65D 83/14; C09K 11/07; C09K 3/30

(52) U.S. Cl. CPC B65D 83/682; B65D 83/205; B65D 83/32; B65D 83/48; C09K 2211/1011; B65D 83/752; C09K 11/07; C09K 3/30; B65D 83/62

(57) ABSTRACT

An chemiluminescent aerosol Sprayer that can be easily held in one hand capable of marking highly visible areas at night time for emergency, military, safety, and fun directly on a variety of substrates and surfaces. In the preferred embodiment of the invention there are two valve assemblies on one fixed container. The invention works by an actuator being depressed on two different valve assemblies in a single fixed container to two different chambers which are pressurized by means of a non-flammable liquid or gaseous propellant. The chemical ingredients from each chamber are mixed by an actuator which simultaneously ejects the contents of each chamber through their respective valve assemblies into the mixing valve of the actuator to produce a gel or spray of chemiluminescent aerosol spray.

### CROSS-REFERENCE TO RELATED APPLICATIONS

U.S. Pat. No. 9,303,820 B2
/287653, 61/431,

### European Patent Number 2,349,912

### FEDERALLY SPONSORED RESEARCH

None

### SEQUENCE LISTING

None

### BACKGROUND

Chemiluminescent has been around since 1928 when Luminol started to be used commercially. It is also seen in nature in fireflies, fish and many other animals. Light sticks that are common place now is two different chemicals in different compartments when mixed causes a chemical reaction that lights up. This invention is an all-purpose aerosol chemiluminescent aerosol sprayer that sprays in a mist or gel a light spray on objects of various substrates and surfaces such as grass, shirts, trail marking, ocean marking, trees emergency messages, industrial safety, military applications, distress calls, police safety during night road stops on cars. Also this invention allows to communicating messages as writing letters, numbers or both such as HELP-911. There has been other attempts to make a chemiluminescent aerosol sprayer such as by Harris U.S. Pat. No. 9,303,820B2 however this one differs because there are two valve assemblies on one container. This invention an improvement because Harris invention U.S. Pat. No. 9,303,820B2 is big and bulky with two cans. Additionally this invention utilizes traditional aerosol technology that has worked in the past and not a complicated bag inside bag system which can have problems in the filling process and tearing of bags.

### SUMMARY OF THE INVENTION

The invention is an chemiluminescent aerosol sprayer used for industrial, recreational and safety uses. Unlike traditional glow sticks this invention is reusable and can actually sprayed on different surfaces. The formulations can also be changed depending on the use so cheaper and more expensive formulations can be utilized.

### OPERATION OF THE INVENTION

The operation of the chemiluminescent aerosol sprayer is simply press down on the actuator which presses on two different and separate valve stems. Both valve stems go to a spring loaded valve assemblies and to dip tubes that one extends to the chemiluminescent fluorescer fluid and the other dip tube extends to the chemiluminescent activator fluid. Both fluids are in flexible chambers or bags under pressure. The pressure in the can brings these liquids up which is traditional aerosol technology and they go into the actuator mixing chamber and out the orifice of the actuator to make chemiluminescent spray in a fine mist or gel.

### BRIEF DESCRIPTION OF THE DRAWINGS

FIG. 1 shows a perspective view of the preferred embodiment of the invention and includes the fixed container with chamber a and chamber 2 and the actuator to spray the chemiluminescent aerosol spray,

FIG. 2 Show a cross sectional view of the actuator

### DETAILED DESCRIPTION

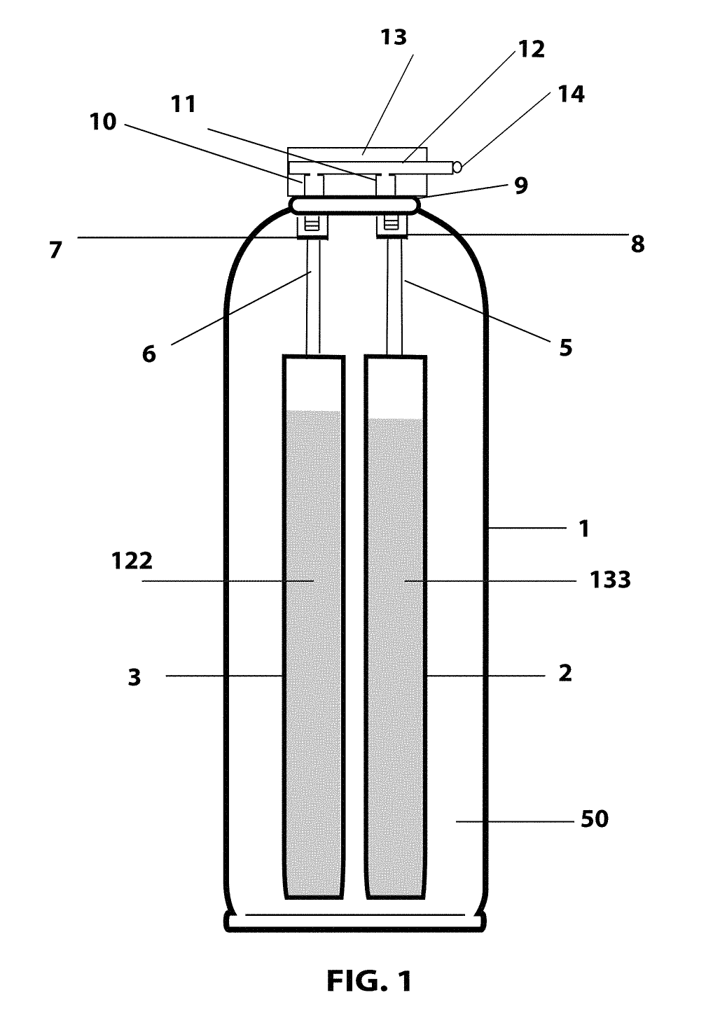

Referring now to FIG. 1, a preferred embodiment of the invention for ejecting a chemiluminescent aerosol spray by means of a co-dispensed aerosol spray using two fixed chambers. The device comprised the first chamber 2 which may be made out of steel, aluminum or plastic flexible bag. And a second chamber 3 which may also be made out of steel, aluminum, plastic or some other suitable material flexible bag. Both first chamber 1 and second chamber 2 are in one fixed container 1 which can be made out of aluminum, steel or plastic. First Chamber 2 has a first reservoir 133 containing a liquid fluorescent dye and the second chamber 3 has a reservoir 122 that contains a liquid oxidizer. Once filled with the chemiluminescent liquid formulation fixed container is sealed with a mounting cup 9. There is two spring loaded valve assemblies on top of the fixed container 1. Valve assembly 8 is spring loaded and has a dip tube 5 connected to it and extends to the first chamber. Valve assembly 7 is spring loaded and has a dip tube 6 that extends to the second chamber 3. Mounting cup 9 holds both valve assemblies in place. Fixed container contains pressurized gas 50 using compressed air or nitrogen or combination of either or other gasses. Both first chamber 2 and second chamber 3 can be filled by injecting liquids through valve assembly or put into the bags filled already. Valve assembly 8 sticks out above the mounting cup 9 out of the fixed container 1 and is valve stem 11. Additionally valve assembly 7 has a valve stem 10 that sticks out above the mounting cup 9 out of the fixed container 1. The device further comprises a actuator 13 that has a mixing chamber 12 that combines the two co-dispensed liquids or gel and orifice in the actuator for the chemiluminescent spray to exit.

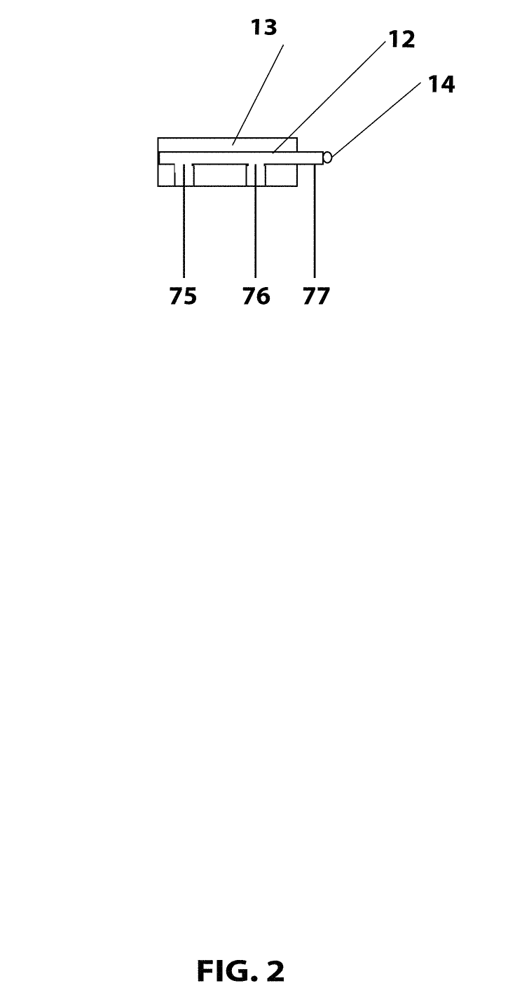

Referring to FIG. 2 the actuator 13 has hole 75 for the second valve stem 10 and hole 76 for the valve stem 1. Both hole 75 and hole 76 lead to the mixing chamber 12. The mixing Chamber 12 sticks out a bit from the actuator for pointing and that is 77 a nozzle that at the end has 14 orifice in the actuator.

1. The invention is:
A. Chemiluminescent Aerosol Sprayer comprising:
1. (A) A reusable and all-purpose chemiluminescent dispensing system comprising;
(a). A fixed container;
(b) at least two chambers in a fixed container, wherein a first chamber contains the first fluid comprising of a chemiluminescent fluorescer fluid and wherein a second chamber contains a second fluid comprising of a chemiluminescent activator fluid.
(c) wherein the first chamber is a flexible chamber and the second chamber is a flexible chamber.
(d) a quantity of pressurized propellant wherein the pressurized propellant is located within the space between the exterior of at least one of said flexible chamber and the interior of the fixed container.
(e) a pair of wholly separate dip tubes wherein one dip tube extends into the first flexible chamber and wherein the other extends within the second flexible container
(f) two totally separate and complete valve assemblies;
one for each dip tube that is totally separate from the other and each of the dip tubes and valve assemblies are not connected in any way.
(g) a dispensing mechanism comprising of an actuator wherein upon depression of the actuator the two valve assemblies both will release the fluids at the same time and mix inside the orifice in the actuator.

2. The invention is:
A. Chemiluminescent Aerosol Sprayer comprising:
1. (A) A reusable and all-purpose chemiluminescent dispensing system comprising;
(a). A fixed container;
(b) at least two chambers in a fixed container, wherein a first chamber contains the first fluid comprising of a chemiluminescent fluorescer fluid and wherein a second chamber contains a second fluid comprising of a chemiluminescent activator fluid.
(c) wherein the first chamber is a flexible chamber and the second chamber is a flexible chamber.
(d) a quantity of pressurized propellant wherein the pressurized propellant is located within the space between the exterior of at least one of said flexible chamber and the interior of the fixed container.
(e) a pair of wholly separate dip tubes wherein one dip tube extends into the first flexible chamber and wherein the other extends within the second flexible container
(f) two totally separate and complete valve assemblies;
one for each dip tube that is totally separate from the other and each of the dip tubes and valve assemblies are not connected in any way.
(g) A Mounting cup to hold both valve assemblies in place.
(h) a dispensing mechanism comprising of an actuator wherein upon depression of the actuator the two valve assemblies both will release the fluids at the same time and mix inside the orifice in the actuator.

3. The reusable all-purpose chemiluminescent aerosol sprayer system in claim 1 wherein one flexible chamber is affixed to or next to the other flexible chamber.

4. The reusable all-purpose chemiluminescent aerosol sprayer system in claim 1 wherein the first flexible chamber and the second flexible chamber is selected from a group consisting of a bag, vessel, pouch, tube and bladder.

5. The reusable all-purpose chemiluminescent aerosol sprayer system in claim 1 wherein the quantity of propellant is sufficient to expel the first fluid and the second fluid to initiate the chemiluminescent reaction from group consisting of nitrogen, air, inert hydrocarbons, such as dimethoxymethanol, ethyl acetone, acetone, dimethyl ether, 2-methoxyethanol, 2-ethoxyethanol, butanol, dimethyl ether, difluoroethane, 1,1,1,2 tetrafluoroethane, petroleum hydrocarbon. 1234ze. also known as 1,3,3.3 Tetrafluoropropene and 1234yf hyfrofluoroolefin.

6. The reusable all-purpose chemiluminescent aerosol sprayer system in claim 1 wherein the chemiluminescent mixture further comprises a quantity of polymeric resin selected from a group consisting of polyhydroxystyrene, polyvinyl alcohol, and carboxymethylcellulose.

7. The reusable all-purpose chemiluminescent aerosol sprayer system in claim 1 wherein the device is sprayed to display and show one of the following selected from a group consisting of: emergency markers, trail marking, letters, numbers, party and celebratory marking, industrial safety, recreation, traffic direction, military tactical work, marine and ocean signaling, decorative, camping, sports and biking safety and can be sprayed on variety of surfaces including concrete, grass, steel, dirt, trees, walls, and water to signal or write messages.

8. The reusable all-purpose chemiluminescent aerosol sprayer system in claim 1 further comprising a plurality of inorganic light scattering compounds selected from the group consisting of: titanium dioxide, talc, barium sulfate, and nano-particulate barium titanate.

9. The reusable all-purpose chemiluminescent aerosol sprayer system in claim 1, further comprising a plurality of organic light scattering compounds selected from the group consisting of micro-sized polymeric spheres.

10. The reusable all-purpose chemiluminescent aerosol sprayer system in claim 1 comprising the steps of
preparing a quantity of fluorescent fluid by combining a fluorescent fluid by combining a fluorescent dye, an oxyalate and a solvent;
Preparing a quantity of an activator fluid by combining hydrogen peroxide, a catalyst and a solvent;
Transferring the quantity of fluorescent fluid into a flexible chamber;
Sealing the first flexible chamber;
Transferring the quantity of activator fluid into a second flexible chamber;
Sealing the second chamber;
Transferring the quantity of propellant into the fixed chamber between one resilient chamber and another resilient chamber, and
Dispensing the quantity of fluorescent fluid and the quantity of activator fluid simultaneously through each having their own complete and separate valve assembly and only touching when in the actuator mixing chamber onto a surface.

11. The reusable all-purpose chemiluminescent aerosol sprayer system in claim 1 said wherein said two flexible chambers are sealed and pressurized to at least atmospheric pressure via pressurization of the fixed container and the dispensing mechanism simultaneously dispenses said fluorescer fluid and said activator fluid in a fine spray or simple gel like line initiating the chemiluminescent reaction and creating a chemiluminescent mixture.

12. The reusable all-purpose chemiluminescent aerosol sprayer system in claim 1 wherein second fluid is made non-flammable and biodegradable by adding polyethylene glycol having an average molecular weight of 200 thereto.

13. The reusable all-purpose chemiluminescent aerosol sprayer system in claim 1, wherein said fluorescer fluid comprises of a fluorescer dye and an oxalate; and said activator fluid is comprised of peroxide.

14. The reusable all-purpose chemiluminescent system according to claim 1, wherein said fluorescer fluid comprises of a fluorescer dye and an oxalate and said activator fluid is comprised of a peroxide and a catalysts.

15. The reusable all-purpose chemiluminescent aerosol sprayer system in claim 1, herein said fluorescer fluid comprises of a anthracene or napthacene dye, selected from the group consisting of 9, 10-diphenylanthrancene, 9, 10-bis(phenylethynyl)anthracene-1-chloro-9,10-bis(phenylethynyl)anthracene, 5,6,11,12-tetraphenyl naphthacene, 5,12-bis(phenylethynyl) naphthacene, and rhodamine; an oxalate, comprised of bis(2-carbopentyloxy-3,5,6-trichlorophenyl) oxalate; and said activator fluid comprised of a peroxide, selected from the group consisting of hydrogen peroxide and urea hydrogen peroxide; and a catalyst, comprised of carboxylic acid salts or phenolic salts, selected from the group consisting of sodium salicylate, tetrabutylammonium salicylate, potassium salicylate, lithium salicylate, tetrabutylammonium salicylate, potassium salicylate, lithium salicylate, tetrahexylammonium salicylate, benzyltrimethylammonium m-chlorobenzoate, or dimagnesium ethylenediamine tetraacetate.

16. The reusable all-purpose chemiluminescent aerosol sprayer system in claim 1, wherein said fluorescer fluid comprises a combination of 9, 10-diphenylanthracene and 1-chloro-9,10-bis(phenyethynyl)anthracene fluorescer dyes, which produces near-white light chemiluminescent emission.

17. The reusable all-purpose chemiluminescent aerosol sprayer system in claim wherein said fluorescer fluid comprises of 16,17-bis(decyloxy)violanthrone fluorescer dye, which produces infrared light emission, with peak of 790 nm.
